(19) United States
(12) Patent Application Publication
(10) Pub. No.: US 2004/0129097 A1
(43) Pub. Date: Jul. 8, 2004

(54) Starting apparatus for an engine

(76) Inventor: Ryoichi Otaki, Fujisawa-shi (JP)

Correspondence Address: KATTEN MUCHIN ZAVIS ROSENMAN, 575 MADISON AVENUE, NEW YORK, NY, 10022-2585, US

(21) Appl. No.: 10/688,850

(22) Filed: Oct. 16, 2003

(30) Foreign Application Priority Data
Apr. 18, 2001 (JP) 2001-120120
Jun. 11, 2001 (JP) 2001-175024

(51) Int. Cl. F02N 15/08

(52) U.S. Cl. 74/7 C; 74/7 E; 475/347

(57) ABSTRACT

In a traction roller type reduction gear (3a) disposed in the middle of a passage for transmitting power from a starter motor to the rotating shaft of an engine, a relation Pmean>{(Umax)^{1/2}}/9 or Pmean>0.3[GPa] is satisfied, assuming the maximum circumferential speed of a drive side cylindrical surface (42) under use state is Umax [m/sec], and the average contact pressure at the radially outer side contact area (50b) of a movable roller (25) based on the preload of a compression coil spring (45) is Pmean [Gpa]. According to the arrangement, transmission efficiency is ensured by preventing slip at both radially inner and outer side contact areas (49a, 49b, 50a, 50b) even during light load operation and damage such as seizure can be prevented.

### TECHNICAL FIELD OF THE INVENTION

This invention relates to improvements to an electric motor with built-in speed reducer that is assembled in the drive unit of various kind of machinery so as to increase the torque at the same time as reducing the speed of the rotation driving force of an electric motor, and particularly, to improvements of a starting apparatus for an engine that, in order to start an engine used e.g. for operating an automobile, starts rotation of the rotating shaft (typically a crank shaft) of the engine by an electric motor with built-in speed reducer.

### BACKGROUND TECHNOLOGY OF THE INVENTION

Assembling a wedge-action type traction-roller speed reducer in between the electric motor, which is the auxiliary power source of an electric-motor-assisted bicycle, and the pedal shafts has been performed up until now. This movable-roller-type speed reducer has only one movable roller and functions as a one-way clutch that transmits rotation in only one direction. Also, this traction-roller speed reducer that is assembled between the electric motor and the pedal shaft transmits power from the electric motor to the pedal shaft, and when the rotation on the pedal side becomes faster than the rotation on the electric motor side, it cuts off the transmission of power in order to prevent the electric motor from resisting the rotation of the pedal shaft.

This kind of electric motor with built-in speed reducer can be used as the power source for a starting apparatus for an automobile engine, the auxiliary power source for an electric-motor-assisted bicycle, the power source for an electric car or hybrid car, etc.

Typically up until now, when used as a starting apparatus for an engine, the electric motor rotated and drove the crankshaft by meshing the pinion formed around the output shaft of the starter motor with the speed-reducing master gear wheel that is formed around the outer peripheral edge of the flywheel fastened to the crankshaft. This pinion moves toward the speed-reducing master gear wheel as power flows to the starter motor and meshes with the speed-reducing master gear wheel, however, when there is no power flowing to the starter motor, the pinion moves away from the speed-reducing master gear wheel to prevent the starter motor from being rotated and driven by the rotation of the crank shaft.

In the case of this starting apparatus for an engine that has been typically used in the past, a loud noise was generated when starting the engine when the pinion and the speed-reducing master gear wheel meshed together. Also, it was impossible to avoid a time lag that occurs after power begins flowing to the starter motor, until the pinion and speed-reducing master gear wheel mesh together and the driving force from the starter motor is transmitted to the crank shaft. Therefore, when this starting apparatus is used for starting a so called ‘Idling Stop’ vehicle, in which the engine is stopped when the automobile stops, and the engine is started when the vehicle is to start moving, a small amount of time is required after performing the start up operation until the vehicle actually starts moving, which can be a cause for the operator to become irritated.

The construction of a starting apparatus for an engine that is capable of doing away with these kinds of problems is disclosed in Japanese patent publication No. Tokukai 2001-59469, and shown in FIG. 16.

This starting apparatus for an engine comprises: a starter motor 1, a traction-roller speed reducer 3 whose input shaft 2 is rotated and driven by this starter motor 1, and a rotation-transmission means 7 that is located between the output shaft 4 of the traction-roller speed reducer 3 and the rotating shaft 6 of the engine 5. This rotation-transmission means 7 is a belt-transmission mechanism comprising a first pulley 8 that is fastened to the output shaft 4 of the traction-roller speed reducer 3, a second pulley 9 that is fastened to the rotating shaft 6 of the engine 5, and an endless belt 10 that runs around the first and second pulleys 8, 9.

When starting the engine 5, power flows to the starter motor 1, and the rotation driving force from the starter motor 1 is transmitted to the rotating shaft 6 of the engine 5 by way of the traction-roller speed reducer 3 and the rotation-transmission means 7. The amount of sound generated by the traction-roller speed reducer 3 during operation (when power is transmitted) is small, so no annoying or harsh sound occurs when starting the engine 5. Also, by using a traction-roller speed reducer 3 that uses a wedge-action that will be explained in detail later, it is possible to transmit large driving forces with good efficiency. Moreover, after starting the engine 5, rotation force of the rotating shaft 6 is not transmitted to the input shaft 2 in order that the starter motor 1 is not rotated and driven at high speed by the engine 5. On the other hand, when starting the engine 5, the rotation of the starter motor 1 is immediately transmitted to the rotating shaft 6, so when using the apparatus as a starting apparatus for the engine of an ‘Idling Stop’ vehicle, it is possible to reduce the cause of irritation to the operator.

As described above, Japanese patent publication No. Tokukai 2001-59469 discloses construction in which a wedge-action type traction-roller speed reducer 3 is assembled in a starting apparatus for an automobile. In the construction of this disclosure, the rotation-drive shaft of the electric motor 1 drives the center roller of the wedge-action type traction-roller speed reducer 3, and the output shaft 4 of this wedge-action type traction-roller speed reducer 3 rotates and drives the drive pulley. Moreover, the endless belt 10 that runs between this drive pulley and the crank pulley that is fastened on the end of the engine's crankshaft rotates and drives the crankshaft according to the power flowing to the electric motor 1. In the case of this prior construction, when starting the engine the driving torque of the rotation-drive shaft increases and is transmitted to the crankshaft, however, after the engine has started, the traction-roller speed reducer functions as a one-way clutch and prevents the rotation of the crank shaft from being transmitted to the rotation-drive shaft.

In other words, the traction-roller speed reducer 3 utilizing wedge-action elastically presses a freely movable roller that is located in the annular space between the outer peripheral surface of the center roller and the inner peripheral surface of the outer ring, which are eccentric with respect to each other, toward the section of the annular space that has a narrow width in the circumferential direction. When the center roller rotates in a direction that causes the movable roller to move toward this narrow section, rotation force is transmitted from the center roller to the outer ring On the other hand, when the center roller is stopped and the outer ring rotates in a direction that causes the movable roller to move toward the wide section of the annular space, the one-way clutch function operates, and the traction-roller speed reducer 3 is set in the overrun state, so that the rotation of the outer ring stops is not transmitted to the center roller.

The traction-roller speed reducer 3 utilizing wedge-action has a one-way clutch function, however, it is impossible to avoid rubbing of part of the outer peripheral surface of the movable roller and the inner peripheral surface of the outer ring even in the so-called overrun state where the driving force is not transmitted. In other words, the movable roller is elastically pushed toward the narrow-width section of the annular space by the elastic force of a spring, and during the overrun state, there is a tendency for the movable roller to move to the wide side of the annular space by the friction force that acts between the inner peripheral surface of the outer ring and outer peripheral surface of the movable roller. Therefore, rubbing inevitably occurs between the inner surface of the outer ring and the outer surface of the movable roller during the overrun state.

Moreover, in order for the movable roller to be moved for sure into the narrow-width section of the annular space when the driving force is transmitted, the elastic force of the spring that presses the movable roller must be somewhat large. Therefore, it cannot be avoided that the friction force that acts between the inner peripheral surface of the outer ring and the outer peripheral surface of the movable roller during the overrun state becomes somewhat large proportional to the elastic force of the spring. Also, when used over a long period of time, wear between the inner peripheral surface of the outer ring and the outer peripheral surface of the movable roller cannot be avoided. Of these surfaces, the inner peripheral surface of the outer ring wears evenly around the entire circumference, so wear itself does not become a problem, however, there is a tendency for the outer peripheral surface of the movable roller to have only partial wear in the circumferential direction. In other words, the traction force that acts between the outer peripheral surface of the movable roller and the inner peripheral surface of the outer ring during the overrun state is limited, and since the center roller is stopped, the movable roller does not rotate on its axis so only part of the outer peripheral surface rubs with the inner peripheral surface of the outer ring. As a result, uneven wear occurs on the movable roller and there is a possibility that the traction-roller speed reducer 3 will no longer be able to function.

In order to deal with this problem, it is possible to place a one-way clutch between the output shaft 4 of the traction-roller speed reducer 3 utilizing wedge-action and a driven member, such as the drive pulley described above that is rotated and driven by the output shaft 4, that transmits the rotation force only from the output shaft 4 to the driven member However, by just using a one-way clutch, there exists the problem in that the apparatus becomes larger and thus the size of the installation space increases.

Also, in order to maintain the transmission efficiency of the wedge-action type traction-roller speed reducer 3 that is assembled in the starting apparatus for an engine that is constructed and functions as described above, it is necessary to maintain contact pressure at the areas of contact between the outer peripheral surface of each roller and the inner peripheral surface of the outer ring of this traction-roller speed reducer 3. When there is insufficient contact pressure at these areas of contact, slipping occurs at the areas of contact, and not only does the efficiency of transmitting driving force from the input shaft 2 to the output shaft 4 become worse, but there is a possibility that damage such as seizure du to friction heat that occurs at the areas of contact will occur.

As will be explained in detail later in the embodiments of this invention, in a state where a large torque is transmitted from the input shaft 2 to the output shaft 4, the movable roller moves to the narrow-width section of the annular space by a large force that corresponds to the torque to be transmitted, so there is always sufficient contact pressure at the areas of contact. On the other hand, in a state where there is hardly any torque transmitted from the input shaft 2 to the output shaft 4, e.g. where the output shaft 4 rotates under no load or a small load, the force that tries to move the movable roller to the narrow-width section of the annular space is only the elastic force of the spring that presses the movable roller. In the case of a typically used prior traction-roller speed reducer 3 utilizing wedge-action, the elastic force of the spring is very small, and no means were considered for controlling the elastic force according to the relationship between the performance and dimensions of the traction-roller speed reducer.

When using the traction-roller speed reducer 3 in the starting apparatus for an engine to which this invention is applied, the problems described above of damage occurring, such as a drop in transmission efficiency or seizure, become obvious. In other words, when rotating and driving (cranking) the rotating shaft 6 of the engine 5 by the starter motor 1 in order to start the engine 5, the torque required for rotating and driving the rotating shaft 6 changes suddenly to correspond with the opening and closing timing of the intake and exhaust valves of the engine 5. When this torque is large, there is no serious slipping occurring at the areas of contact inside the traction-roller speed reducer 3. However, when the torque required to rotate and drive the rotating shaft 6 drops suddenly, and when the input shaft 2 of the traction-roller speed reducer 3 continues to be rotated and driven at high speed by the starter motor 1, it becomes easy for the serious slipping at the areas of contact to occur. Taking these conditions into consideration, it becomes necessary to consider the size of the force that tries to move the movable roller of the traction-roller speed reducer 3 to the narrow-width section of the annular space even when there is only a small load or no load, and to prevent slipping from occurring.

### SUMMARY OF THE INVENTION

Taking the problems mentioned above into consideration, an object of this invention is to provide a starting apparatus for an engine that secures the transmission efficiency of the traction-roller speed reducer and prevents the occurrence of damage such as seizure.

Another object of this invention is to provide construction for a starting apparatus for an engine that is compact and in which there is no wear of the outer peripheral surface of the movable roller when the traction-roller speed reducer utilizing wedge-action is in the overrun state.

A further objective of this invention is to provide an electric motor with built-in speed reducer that is compact, has good durability and is suitable for assembly in machinery such as a starting apparatus for an engine.

### BRIEF DESCRIPTION OF THE DRAWINGS

FIG. 1 is a cross sectional view taken along the line A-A in FIG. 2 to show a first example of the embodiment of the present invention.

FIG. 2 is a cross sectional view taken along the line 1B-B in FIG. 1.

FIG. 3 is an enlarged cross sectional view taken along the line C-C in FIG. 2.

FIG. 4 is a brief side elevational view to show a test apparatus to obtain a slide limit speed.

FIG. 5 is a graph to show a test result.

FIG. 6 is a cross sectional view of an outer ring to show a second example of the embodiment of the present invention.

FIG. 7 is an enlarged view of Portion D in FIG. 6.

FIG. 8 is a diagramatical view to show an outer ring, intermediate roller and center roller in combination.

FIG. 9 is a cross sectional view of an outer ring to show a third example of the embodiment of the present invention.

FIG. 10 is an enlarged view of Portion E in FIG. 9.

FIG. 11 is an enlarged view of Portion F in FIG. 9.

FIG. 12 is a diagramatical view of an outer ring and center roller in combination.

FIG. 13 is a diagramatical view to show another three examples of the convex portion.

FIG. 14 is a cross sectional view to show a fourth example of the embodiment of the present invention.

FIG. 15 is a cross sectional view taken along the line G-G in FIG. 14.

FIG. 16 is a diagramatical view of one example of the starting apparatus for engine to which the present invention is applied.

### DETAILED DESCRIPTION OF THE PREFERRED EMBODIMENT

The starting apparatus for an engine in the embodiment of this invention comprises a traction-roller speed reducer and rotation-force transmission means that are located between the starter motor and rotating shaft of the engine, such that they are in series with respect to the direction of transmission of the driving force.

Of these, the traction-roller speed reducer comprises: a housing; an input shaft that can rotate freely with respect to the housing, a center roller that is concentric with the end of the input shaft and to which the rotation force is freely transmitted and whose outer peripheral surface is taken to be a drive-side cylindrical surface; an outer ring that is located around the center roller and whose inner peripheral surface is taken to be the driven-side cylindrical surface that rotates relative to the center roller; an output shaft that is concentric with the outer ring and where one end is linked to the outer ring such that rotation force can be free transmitted and is supported such that it rotates freely with respect to the housing; a plurality of pivot shafts that arc located in the annular space between the drive-side cylindrical surface and the driven-side cylindrical surface such that they are arranged parallel with the center roller; and a plurality of intermediate rollers that are supported by the pivot shafts such that they rotate freely and whose outer peripheral surfaces are taken to be the driving-force-transmission cylindrical surfaces.

By making the center of the center roller eccentric with the center of the outer ring, the width dimension of the annual space is not uniform around in the circumferential direction, and by making one of the plurality of intermediate rollers a movable roller that is supported such that it can move freely in the circumferential direction inside the annular space and the remaining intermediate rollers fixed rollers, the intermediate roller that is the movable roller will freely move toward the narrow-width section of the annular space when the center roller and outer ring rotate in a specified direction.

By elastically pressing the intermediate roller that is the movable roller toward the narrow-width section of the annular space, a pre-load is applied for causing contact pressure to occur at the areas of contact between the driving-force-transmission cylindrical surface on the intermediate roller that is the movable roller and the drive-side cylindrical surface and driven-side cylindrical surface even in the no-load state. When the maximum value of the circumferential speed of the drive-side cylindrical surface during operation is taken to be Umax [m/sec], and the average value of the contact pressure due to pre-loading at the areas of contact between the driven-side cylindrical surface and the driving-force-transmission cylindrical surface on the intermediate roller that is the movable roller is taken to be Pmean [GPa], then it is possible to satisfy the condition Pmean>{(Umax)^{1/2}}/9.

Also, when the average value of the contact pressure due to pre-loading at the point of contact between the driven-side cylindrical surface and the driving-force-transmission cylindrical surface on the intermediate roller that is the movable roller is taken to be Pmean [GPa], it is possible to satisfy the condition Pmean>0.3 [GPa].

With this kind of construction, it is possible to provide a starting apparatus for an engine that maintains contact pressure at the inner point of contact and outer point of contact that are the areas of contact between the outer peripheral surface of the rollers of the traction-roller speed reducer and the inner peripheral surface of the outer ring, that maintains transmission efficiency by making it difficult for slipping to occur at the areas of contact, and that prevents the occurrence of damage such as seizure from occurring.

Also, the electric motor with built-in speed reducer of this invention comprises: an electric motor, a rotation-drive shaft of this electric motor, an input shaft that is joined to the tip end of the rotation-drive shaft, and a speed reducer that reduces the speed of rotation of the input shaft before transmitting the rotation to the output shaft.

This speed reducer is a traction-roller speed reducer utilizing wedge-action and comprises: a center roller that is joined to the aforementioned input shaft; an outer ring that is located around the center roller and which is eccentric with the center roller; and at least two fixed roller and one movable roller, whose outer peripheral surfaces are driving-force-transmission cylindrical surfaces, and that are located in the annular space between the drive-side cylindrical surface that is the outer peripheral surface of the center roller and the driven-side cylindrical surface that is the inner peripheral surface of the outer ring, whose width in the radial direction is not uniform around in the circumferential direction.

The fixed rollers are supported such that they can rotate freely only around their support axis, and the movable roller is supported such that it can rotate around its support axis and also supported such that it can move in at least the circumferential direction of the annular space, and that it can be elastically pressed toward the narrow-width section of the annular space.

The output shaft of the traction-roller speed reducer and the outer ring are arranged such that they are substantially concentric with each other and such that they rotate relative to each other. At least one section of the base end of the output shaft is inserted inside the radially inner side of the outer ring, and a one-way clutch is located between the outer peripheral surface of the base end of this output shaft and the outer ring. This one-way clutch is connected only when rotation of the outer ring based on the electric power flowing to the electric motor is transmitted to the output shaft.

With the electric motor with built-in speed reducer of this invention constructed as described above, it is possible to rotate and drive the output shaft of the traction-roller speed reducer with a large torque based on the electric power flowing to the electric motor. On the other hand, when the rotation angular speed of this output shaft becomes faster than the rotation angular speed of the outer ring of the traction-roller speed reducer, e.g. when the output shaft rotates with the motor stopped, the one-way clutch becomes disconnected such that rotation of the output shaft is not transmitted to the outer ring of the traction-roller speed reducer. As a result, the outer ring stops, so there is no rubbing between the inner peripheral surface of the outer ring and part of the outer peripheral surface of the movable roller, and thus it is possible to prevent wear on just part of the outer peripheral surface of the movable roller.

Now, some examples of the embodiment of the present invention are detailed referring to the attached drawings.

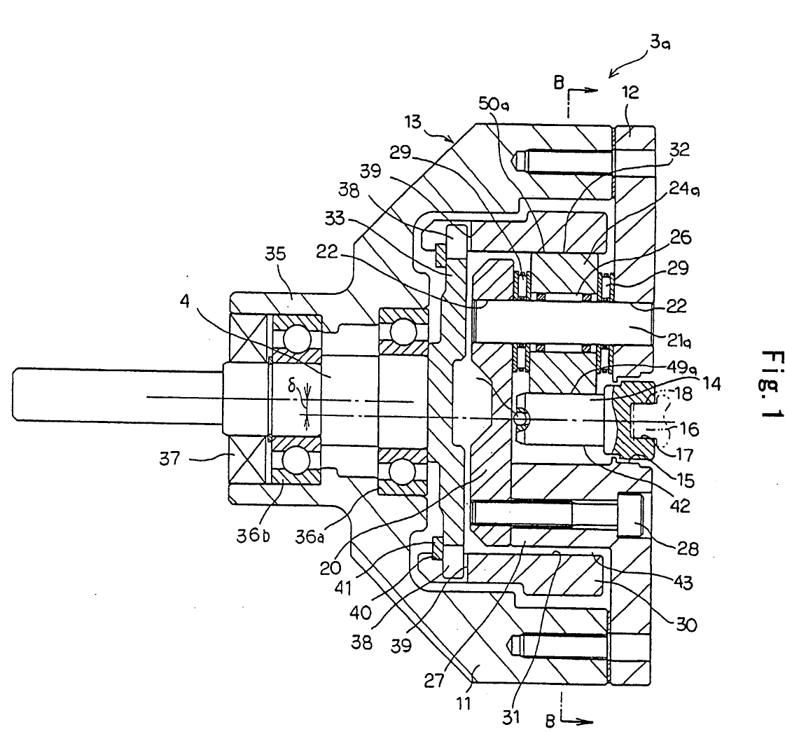

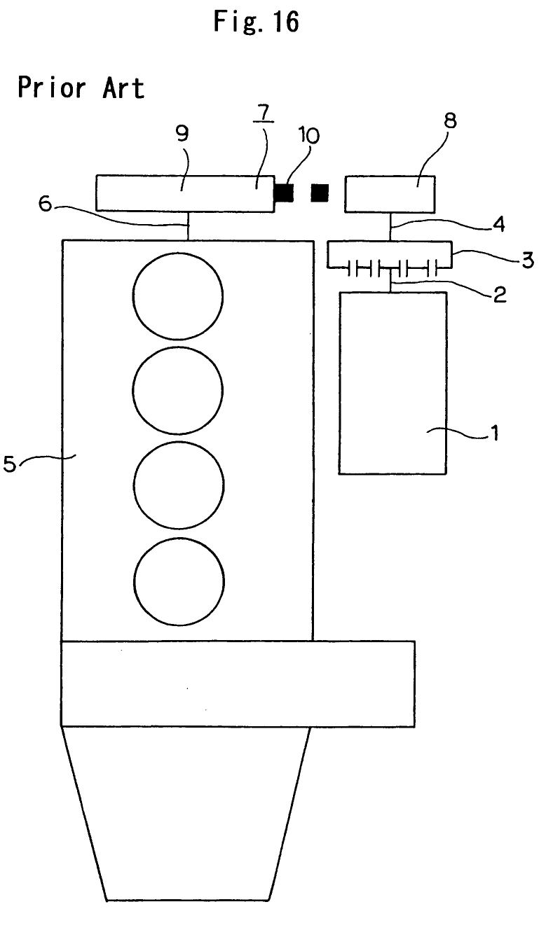

FIGS. 1 to 3 show a first example of the embodiment of the invention. A feature of the staring apparatus for an engine of this invention is that by designing the specifications of the traction-roller speed reducer 3 that reduces the speed of the starter motor 1 and transmits the rotation of the starter motor 1 to the engine 5 (see FIG. 16), it is possible to improve the durability of the traction-roller speed reducer 3. The mechanism that combines this traction-roller speed reducer 3 and a rotation-force-transmission means 7 (see FIG. 16) to transmit the rotation force from the starter motor 1 to the rotating shaft 6 of the engine 5 is substantially the same as the construction disclosed in Japanese patent No. 2001-59469 which includes the construction shown in FIG. 16. Furthermore, it is also possible to employ construction in which the output of the traction-roller speed reducer is transmitted to the rotating shaft by a gear-transmission mechanism comprising a speed-reducing pinion gear that is fastened to the output shaft of the traction-roller speed reducer and a speed-reducing master gear that is fastened to the rotating shaft of the engine to mesh with the speed-reducing pinion gear. By using this kind of gear-transmission mechanism, a little noise is generated by the gear section, however, since the gears can always be in the meshed state, any large noise, like that which was generated during operation of a typical prior starting apparatus for an engine is not produced.

In either case, the mechanism for transmitting the rotation force of the starter motor 1 to the rotating shaft 6 of the engine 5 can be selected by the operator from among the various known mechanisms, so drawings and an explanation of the mechanism are omitted here, and only the construction of the traction-roller speed reducer, which is the feature of this invention, will be explained below.

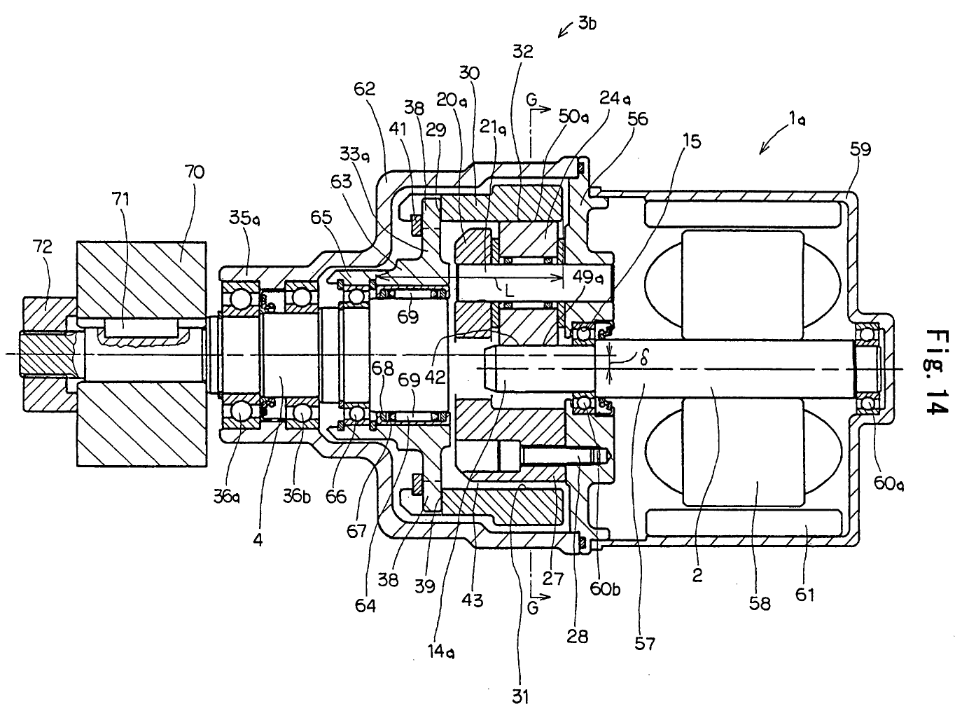

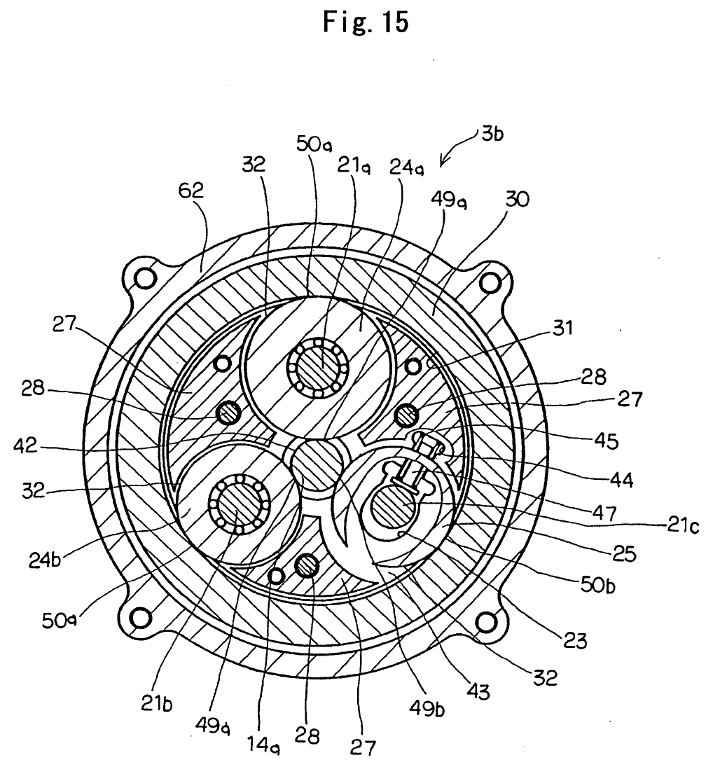

The traction-roller speed reducer 3a of this embodiment has a stationary housing 13 that comprises a cylindrical-shaped main unit 11 with a bottom that is made of steel or aluminum alloy and a steel cover 12 that covers the opening on the base end of the main unit 11. Also, the inner half (left half in FIG. 1) of a center roller 14 is inserted inside the housing 13 through a through hole 15 that is formed in the center portion of the cover 12. This through hole 15 is located in a position that is offset a little from the center of the cover 12. Also, the end of the drive shaft 16 of the starter motor (not shown in the figure), which is the input shaft, is connected to the outside end (right end in FIG. 1) of the center roller 14. The main unit 11 corresponds to the speed-reducer case 62 and the cover 12 corresponds to the partition plate 56 in FIG. 14 and FIG. 15.

In the case of the example shown in the figures, the center roller 14 is located such that it can be freely rotated and driven by the drive shaft 16, while at the same time it can freely move a little in the radial direction (radial direction of the center roller 14 itself). Therefore, in this example, the inner diameter of the through hole 15 is larger than the outer diameter of the center roller 14 such that the center roller 14 can move inside this through hole 15 in the radial direction. Also, together with forming a concave fitting groove 17 that runs in the radial direction on the base end surface (surface on the right end in FIG. 1) of the center roller 14, a convex fitting section 18 that runs in the radial direction is formed on the tip end surface (surface on the left end in FIG. 1) of the drive shaft 16. This convex fitting section 18 is fitted loosely with the concave fitting groove 17. In order to do this, the width of the concave fitting groove 17 is just a little wider than the width of the convex fitting section 18. Therefore, the center roller 14 and drive shaft 16 are connected to each other such that rotation force can be freely transmitted and such that they can freely move relative to each other in the radial direction. The construction for connecting the center roller 14 and drive shaft 16 such that rotation force can be freely transmitted and such that they can freely move relative to each other in the radial direction is not limited to that shown in the figure, and a loose spline joint or loose key joint.

Also, a steel ball 19 is pressure fitted and fastened to the center of the tip end surface (surface on the left end in FIG. 1) of the center roller 14, and this steel ball 19 protrudes out and comes in contact with the center section of one surface (right surface in FIG. 1) of a connecting plate 20, which will be described later, to form a pivot bearing. This pivot bearing is used such that the center roller 14 can rotate freely and so that it is possible to position the center roller 14 in the axial direction. In the case of this embodiment, there is a clearance between the outer peripheral surface of the center roller 14 and the inner peripheral surface of the through hole 15. A seal member is placed between the casing of the starter motor (not shown in the figure) and the cover 12 in order to prevent foreign matter from getting inside the housing 13 through this clearance. It is also possible to place a seal ring, such as an elastically deformable O-ring, between the outer peripheral surface of the center roller 14 and the inner peripheral surface of the through hole 15 to cover this clearance.

Also, there are three pivot shafts 21a, 21b, 21c located inside the housing 13 in the section surrounding the center roller 14 and they are arranged such that they are parallel with the center roller 14. In other words, one end (right end in FIG. 1) of these pivot shafts 21a, 21b, 21c is supported by the cover 12, and the other end (left end in FIG. 1) is supported by the connecting plate 20. This connecting plate 20 is not formed into a circular ring shape but is formed into a circular plate shape. The reason for this is that it is used to form the pivot bearing.

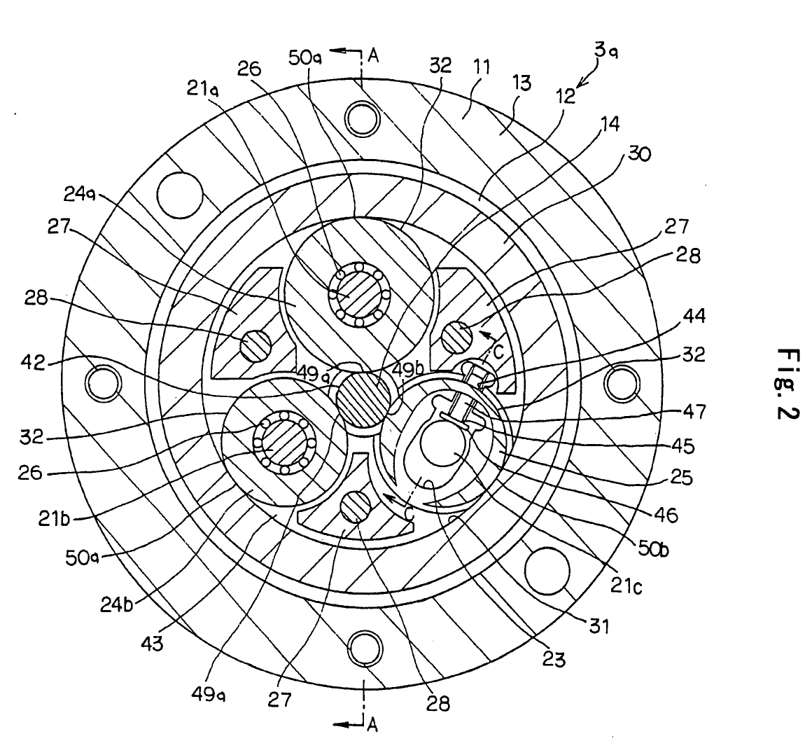

Moreover, of the three pivot shafts 21a, 21b, 21c, both ends of the two pivot shafts 21a, 21b, which are located at the top center and bottom left side in FIG. 2, are pressure fitted and fastened inside fitting holes 22 that are formed in the cover 12 and connecting plate 20. Therefore, neither of these pivot shafts 21a, 21b move inside the housing 13 in the circumferential direction or radial direction. On the other hand, both ends of the remaining pivot shaft 21c, which is located at the lower right side in FIG. 2, are supported by the cover 12 and connecting plate 20 such that it can move freely a little in the circumferential direction and radial direction of the housing 13. In order to for that, support holes 23 that are wider and longer than the outer diameter of the pivot shaft 21c are formed in sections on part of the cover 12 and connecting plate 20 in alignment with both ends of the pivot shaft 21c, and both ends of the pivot shaft 21c loosely fit in these support holes 23.

Also, the fixed intermediate rollers 24a, 24b and movable intermediate roller 25 are supported such that they can rotate freely around the middle section of these pivot shafts 21a, 21b, 21c by radial needle roller bearings 26. The connecting plate 20 comes in contact with a protruding section 27 that protrudes from part of the inner surface of the cover 12 (surface on the side of space where the fixed rollers 24a, 24b and movable roller 25 are located, or the left surface in FIG. 1), displaced from the fixed rollers 24a, 24b and movable roller 25, and is fastened to the cover 12 by a connecting bolt 28. Also, there are thrust needle roller bearings 29 located between the both end surfaces in the axial direction of the fixed rollers 24a, 24b and movable roller 25 and the connecting plate 20 and cover 12, and they make it possible for the rollers 24a, 24b, 25 to rotate smoothly.

Moreover, a cylindrical shaped outer ring 30 is located inside the housing 13 at a portion surrounding the fixed rollers 24a, 24b and movable roller 25, and the inner peripheral surface of this outer ring 30 is taken to be the driven-side cylindrical surface 31. And, this driven-side cylindrical surface 31 freely comes in contact with the driving-force-transmission cylindrical surfaces 32, which are the outer peripheral surfaces of the fixed rollers 24a, 24b and movable roller 25. Also, the outer shaft 4 is connected to the outer ring 30 by way of a collar section 33. This output shaft 4 is inserted through the inside of a support cylinder 35 that is formed in the center of the main unit 11 of the housing 13 and protrudes out from the housing 13. In the example shown in the figure, the output shaft 4 is supported inside the support cylinder 35 by a pair of ball bearings 36a, 36b such that it can rotate freely, and a seal ring 37 covers the space between the opening on the tip end of the support cylinder 35 and the inner peripheral surface in the middle section of the output shaft 4.

In the case of this example, the outer ring 30 is located inside the housing 13 such that it can rotate freely and move a little in the radial direction. In other words, in this example, an outward facing flange-shaped collar section 33 is formed on the base end (right end in FIG. 1) of the output shaft 4. Also, protrusions 38 that are formed around the outer peripheral edge of this collar section 33 is engaged with notches 39 that are formed on the edge of one end (edge on the left end in FIG. 1) in the axial direction of the outer ring 30 such that they can move a little in the radial direction. Moreover, when these protrusions 38 arc all the way to the back section (right section in FIG. 1) of the notches 39, a retaining ring 41 fits into at fitting groove 40 that is formed around the inner peripheral surface on the end of the outer ring 30 such that the protrusions 38 do not come out from the notches 39. Therefore, the outer ring 30 and output shaft 4 are connected such that rotation force can be freely transmitted and such that they can move relative to each other in the radial direction.

Also, each of the driving-force-transmission cylindrical surfaces 32, which are the outer peripheral surfaces of the fixed rollers 24a. 24b and movable roller 25, comes in contact with the drive-side cylindrical surface 42, which is the outer peripheral surface of the center roller 14, and the driven-side cylindrical surface 31, which is the inner peripheral surface of the outer ring 30. The center of the center roller 14 is eccentric with the center of the output shaft 4 and outer ring 30. In other words, as was described above, the through hole 15 through which the center roller 14 passes is located a little offset from the center of the housing 13, however, the support cylinder 35 through which the output shaft 4 passes is located in the center of the housing 13. Also, the output shaft 4 that is supported such that it rotates freely inside the support cylinder 35 is practically concentric with the outer ring 30. Therefore, the center roller 14 is eccentric with respect to the outer ring 30 and output shaft 4 by just the amount δ that the through hole 15 is offset from the center of the housing 13 (see FIG. 1). Moreover, the width dimension of the annular space 43 between the drive-side cylindrical surface 42 that is formed around the outer peripheral surface of the center roller 14 and the driven-side cylindrical surface 31 that is formed around the outer ring 30, where the fixed rollers 24a, 25b and movable roller 25 are located, is not uniform around the circumferential direction by an amount that corresponds to this amount δ of eccentricity.

The outer diameters of the fixed rollers 24a, 24b and movable roller 25 differ by the amount that the width dimension of the annular space 43 is not uniform around the circumferential direction. In other words, the diameters of the fixed roller 24b and movable roller 25, which are located on the side where the center roller 14 is offset with respect to the outer ring 30 (lower side in FIG. 2), are the same to each other and are relatively small diameters. On the other hand, the outer diameter of the fixed roller 24a, which is located on the opposite side from where the center roller 14 is offset with respect to the outer ring 30, is larger than the outer diameter of the fixed roller 24b and movable roller 25. Also, the three driving-force-transmission cylindrical surfaces 32, which are the outer peripheral surfaces of the fixed intermediate rollers 24a, 24b and the movable intermediate roller 25, comes in contact with the drive-side cylindrical surface 42 and driven-side cylindrical surface 31.

Of the two fixed intermediate rollers 24a, 24b and the one movable intermediate roller 25, the pivot shafts 21a, 21b that support both of the fixed rollers 24a, 24b are fixed inside the housing 13 as described above. On the other hand, the pivot shaft 21c that supports the movable roller 25 is supported inside the housing 13, also as described above, such that it can free move a little in the circumferential direction and radial direction. Therefore, the movable roller 25 can also freely move a little inside the housing 13 in the circumferential direction and radial direction. Also, elastic members such as compression coil springs 45 are mounted inside cylinder holes 44 in the cover 12 and connecting plate 20 to elastically press the pivot shaft 21c that supports the movable roller 25, in order that the movable roller 25 that is supported to rotate freely by the pivot shaft 21c moves toward the narrow-width section of the annular space 43.

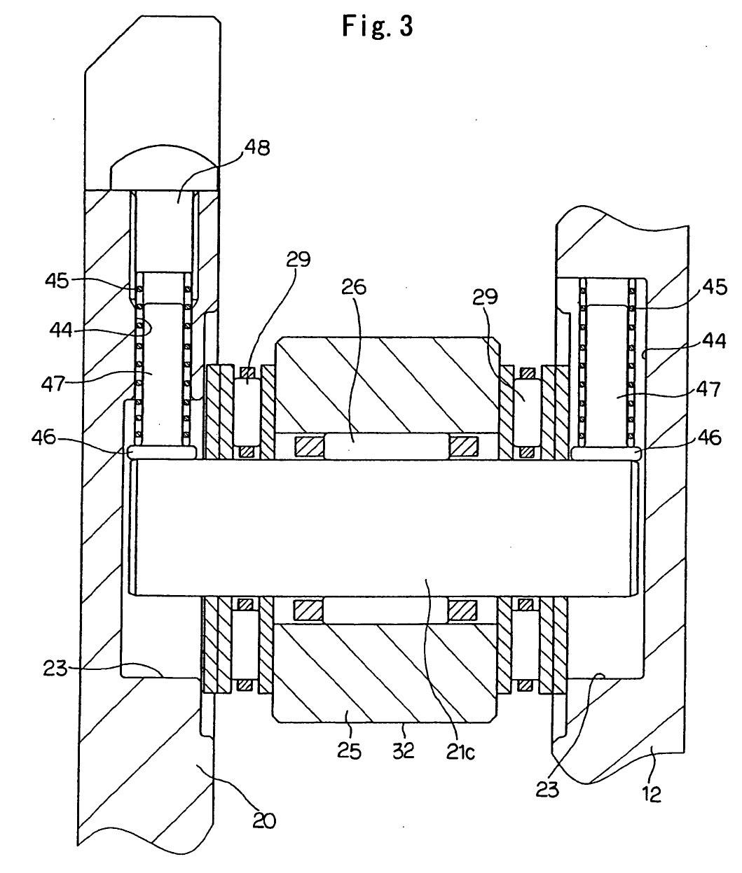

In the example shown in the figures, the compression coil springs 45 press pressure pins 47 that are formed with an outward-facing flange-shaped collar section 46 on the tip end of each pin 47 (bottom left ends in FIG. 2, bottom end in FIG. 3), and both of these pressure pins 47 press both ends of the pivot shaft 21c in the same direction. Of the openings on both ends of the cylinder holes 44, the openings on the sides opposite the support holes 23 are covered by a screw-on cover 48. Each of the compression coil springs 45 is located between this screw-on cover 48 or inner surface on the end of the cylinder hole 44 and the collar section 46, and applies an elastic force to the respective pressure pins 47 in the aforementioned direction.

In the case of the traction-roller speed reducer 3a assembled in the starting apparatus for an engine of this invention, by controlling the elastic force of each of the compression coils springs 45, it is possible to maintain transmission efficiency, and prevent damage such as seizure from occurring even when used at a high maximum operating rpm. In other words, by making the elastic force of each of the compression coil springs 45 sufficiently large, no slipping occurs at the radially inner contact areas 49a, 49b, which are the areas of contact between the drive-side cylindrical surface 42 on the outer peripheral surface of the center roller 14 and the driving-force-transmission cylindrical surfaces 32 on the outer peripheral surfaces of the fixed rollers 24a, 24b and movable roller 25, and the radially outer contact areas 50a, 50b, which are the areas of contact between the driven-side cylindrical surface 31 on inner peripheral surface of the outer ring 30 and the driving-force-transmission cylindrical surfaces 32, regardless of the operating state of the traction-roller speed reducer 3a. Since there is no slipping at the areas of contact 49a, 49b, 50a, 50b, the minimum value of the elastic force of each of compression coil springs 45 satisfies at least one of the following conditions [1] or [2].

[1.] When the maximum value of the circumferential speed in use of the drive-side cylindrical surface 42, which is the outer peripheral surface of the center roller 14, is taken to be Umax [m/sec], and the average value of the contact pressure at the radially outer contact point 50b, which is the point of contact between the driven-side cylindrical surface 31, which is the inner peripheral surface of the outer ring 30, and the driving-force-transmission cylindrical surface 32, which is the outer peripheral surface of the movable roller 25, due to the pre-loading by the elastic force of each of the compression coil springs 45 is taken to be Pmean [GPa], then the condition Pmean>{(Umax)/^{1/2}}/9 is satisfied.

[2.] When the average value of the contact pressure at the radially outer contact area 50b due to pre-loading by the elastic force of each of the compression coil springs 45 is taken to be Pmean [GPa], then the condition Pmean>0.3 [GPa] is satisfied. In this case, it does not matter what the maximum value of the circumferential speed Umax of the drive-side cylindrical surface 42 during operation is.

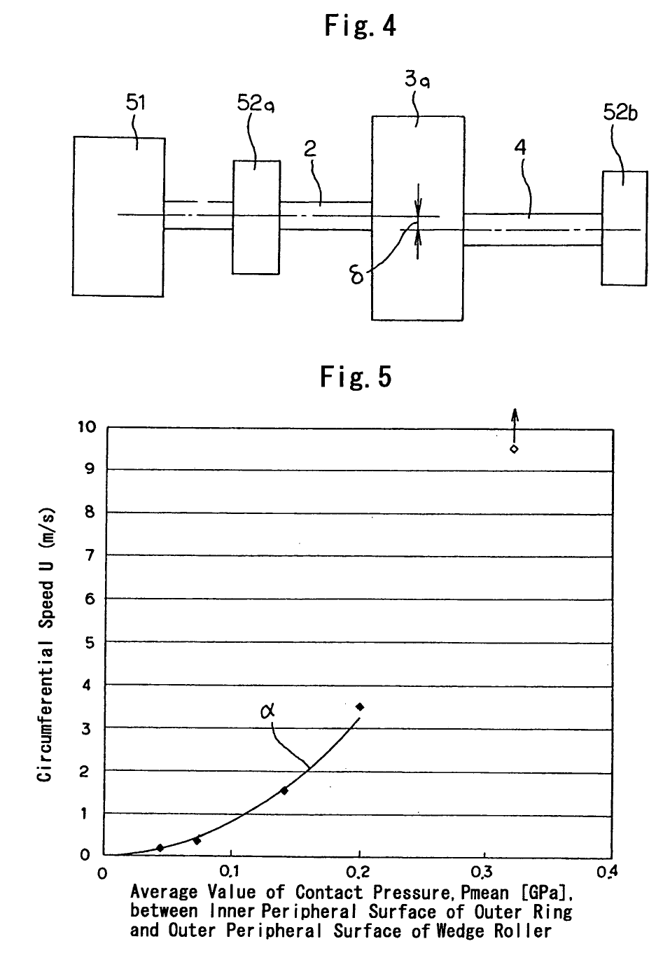

By satisfying one (or both) of the conditions above, this invention maintains the transmission efficiency of the traction-roller speed reducer 3a that is assembled in the starting apparatus for an engine, and prevents damage such as seizure from occurring. Next, FIGS. 4 and 5 will be used to explain a test performed by the inventors in order to find the conditions [1] and [2] above.

As shown in FIG. 4, in the test, an electric motor 51 rotated and drove the input shaft 2 of the traction-roller speed reducer 3a, constructed as shown in FIGS. 1 to 3 and having a speed-reduction ratio ‘i’, at a speed of Nin (min⁻¹) Also, the rotating speed Nin of the input shaft 2 was measured by a tachometer 52a, and the rotating speed Nout of the output shaft 4 of the traction-roller speed reducer 3a was measured by a tachometer 52b. When the slip factor S found from Equation (1) below exceeded 5% (S>0.05), it was determined that the rotating speed of the input shaft 2 of the traction-roller speed reducer 3a exceeded the sliding-limit speed. Also, the effect of the average value Pmean [GPa] of the contact pressure at the radially outer contact area 50b in the traction-roller speed reducer 3a, and the effect of circumferential speed U [m/sec], which was found from Equation (2) below, of the drive-side cylindrical surface 42, which is the outer peripheral surface of the center roller 14 of the traction-roller speed reducer 3a having an outer diameter Din, on the sliding-limit speed were found and the results that were obtained are shown in FIG. 5.

S=(Nin−i·*Nout)/Nin (1)

U=π·Din·Nin (2)

The average value of the contact pressure Pmean [GPa] at the radially outer contact area 50b is shown along the horizontal axis of the table in FIG. 5 showing the experimental results, and the circumferential speed U [m/sec] of the drive-side cylindrical surface 42 is shown along the vertical axis. Moreover, the mark ‘♦’ in FIG. 5 shows the sliding-limit speed. By taking the horizontal axis in FIG. 5 to be the x-axis, and similarly, the vertical axis to be the y-axis, then the curve α that connects the marks ‘♦’ can be approximated by y=81x². From this it can be seen that when condition [1] above is satisfied, the slip factor S between the input shaft 2 and output shaft 4 of the traction-roller speed reducer 3a is kept below 5% Also, as shown by the ‘⋄’ mark in FIG. 5, when the average value of the contact pressure Pmean [GPa] at the radially outer contact area 50b becomes a little greater than 0.3 [GPa]. then the slip factor is kept less than 5% regardless of the circumferential speed U [m/sec] of the drive-side cylindrical surface 42 (regardless of how fast the circumferential speed becomes). This is because, when the average value of the contact pressure Pmean [GPa] at the radially outer contact area 50b is greater than 0.3 [GPa], the movable roller 25 moves toward the narrow-width side of the annular space 43 for sure, even when the output shaft 4 is in a no-load state, and the surface pressure at the radially inner contact areas 49a, 49b and radially outer contact areas 50a, 50b rises.

In the case of the traction-roller speed reducer 3a assembled in the starting apparatus for an engine of this invention, constructed as described above, rotation of the center roller 14 that is connected to the drive shaft 16 is transmitted to fixed rollers 24a, 24b and movable roller 25 by way of the radially inner contact areas 49a, 49b, which are the contact areas between the drive-side cylindrical surface 42 that is the outer peripheral surface of the center roller 14, and the driving-force-transmission cylindrical surfaces that are the outer peripheral surfaces of the fixed rollers 24a, 24b and movable roller 25. Furthermore, the rotation of the fixed rollers 24a, 24b and movable roller 25 is transmitted to the outer ring 30 by way of the radially outer contact areas 50a, 50b, which are the contact areas between the aforementioned driving-force-transmission cylindrical surfaces 32 and the driven-side cylindrical surface 31 that is formed around the inner peripheral surface of the outer ring 30. Also, the output shaft 4 that is connected to the outer ring 30 rotates in the opposite direction from the center roller 14.

When the center roller 14 rotates in the clockwise direction of FIG. 2 in order that the drive shaft 16 can rotate and drive the output shaft 4, the force applied by this center roller 14 and the elastic force from each of the compression coil springs 45 move the movable roller 25 toward the narrow-width section (center section at the lower side in FIG. 2) inside the annular space 43 that exists between the drive-side cylindrical surface 42 and the driven-side cylindrical surface 31. As a result, the driving-force-transmission cylindrical surface 32, which is the outer peripheral surface of the movable roller 25, presses strongly against the drive-side cylindrical surface 42 and driven-side cylindrical surface 31. Also, the contact pressure at both the radially inner contact area 49b, which is the point of contact between the driving-force-transmission cylindrical surface 32 on the movable roller 25 and the drive-side cylindrical surface 42, and the radially outer contact area 50b, which is the point of contact between the driving-force-transmission cylindrical surface 32 on the movable roller 25 and the driven-side cylindrical surface 31, increases.

When the contact pressures at the radially inner contact area 49b and radially outer contact area 50 of the movable roller 25 increase, either the center roller 14 or outer ring 30 or both move a little in their respective radial direction due to the assembly gaps or elastic deformation. As a result, the contact pressure at the two radially inner contact areas 49a, which are the areas of contact between the driving-force-transmission cylindrical surfaces 32 that are the outer peripheral surfaces of the remaining two fixed intermediate rollers 24a, 24b and the drive-side cylindrical surface 42 that is the outer peripheral surface of the center roller 14, and the two radially outer contact areas 50a, which are the areas of contact between the driving-force-transmission cylindrical surfaces 32 that are the outer peripheral surfaces of the fixed rollers 24a, 24b and the driven-side cylindrical surface 31 that is the inner peripheral surface of the outer ring 30, increases. Also, the outer ring 30 and output shaft 4 rotate in the counterclockwise direction of FIG. 2.

The force that tries to move the movable roller 25 inside the annular space 43 toward the narrow-width section of this annular space 43 changes according to the size of the torque that is transmitted from the center roller 14 to the outer ring 30. In other words, the larger the driving torque from the center roller 14 is, the larger the force is that tries to move the movable roller 25 toward the narrow-width section of the annular space 43. Also, the larger this force is, the larger the contact pressures at the radially inner contact areas 49a, 49b and radially outer contact areas 50a, 50b become. That is, when the driving torque is small, the contact pressures at the radially inner contact areas 49a 49b and the radially outer contact areas 50a, 50b are low. Therefore, the contact pressures at each of the areas of contact 49a, 49b, 50a, 50b can be kept at a proper value according to the size of the torque that is transmitted between the drive shaft 16 and output shaft 4, and thus it is possible to increase the transmission efficiency of the traction-roller speed reducer. In this state, the clutch mechanism is ON.

As was described above, in the case of this invention, the elastic force from each of the compression coil springs 45 is maintained, so it is possible to maintain contact pressure at the radially inner contact areas 49a, 49b and radially outer contact areas 50a, 50b. In other words, as the torque for rotating and driving the rotating shaft 6 of the engine 5 suddenly decreases in the cranking process for starting the engine 5, it is possible to maintain the contact pressure at the areas of contact 49a, 49b, 50a, 50b even when the output shaft 4 rotates in a light-load state or in no load state so that and the torque to be transmitted between the drive shaft 16 and output shaft 4 becomes very small. Therefore, it is possible to prevent severe slipping at these areas of contact 49a, 49b, 50a, 50b, and also prevent damage such as seizure from occurring.

On the other hand, when the drive shaft 16 is stopped and the outer ring 30 rotates in the counterclockwise direction of FIG. 2, the movable roller 25 moves, due to the force applied from the outer ring 30, against the elastic force from the compression coil springs 45, toward the wide section (center section on the right side in FIG. 2) of the annular space 43. As a result, the driving-force-transmission cylindrical surface 32 that is the outer peripheral surface of the movable roller 25 stops pressing against the drive-side cylindrical surface 42 and driven-side cylindrical surface 31. Moreover, the contact pressures at the radially inner contact areas 49a, 49b, which are the areas of contact between the driving-force-transmission cylindrical surfaces 32 of the movable roller 25 and fixed rollers 24a, 24b and the drive-side cylindrical surface 42, and the radially outer contact areas 50a, 50b, which are the areas of contact between the driving-force-transmission cylindrical surfaces 32 of the movable roller 25 and fixed rollers 24a, 24b and the driven-side cylindrical surface 31, drop or disappear. As a result, the rotation of the outer ring 30 is not transmitted to the drive shaft 16. In this state, the clutch mechanism is OFF. Furthermore, in the case of the traction-roller speed reducer 3a shown in the figures, it is possible to keep the contact surface pressures at the areas of contact between the driving-force-transmission cylindrical surfaces 32, which are the outer peripheral surfaces of the fixed rollers 24a, 24b and movable roller 25, and the drive-side cylindrical surface 42, which is the outer peripheral surface of the center roller 14, and the driven-side cylindrical surface 31, which is the inner peripheral surface of the outer ring 30, within the design values even when the outer diameter or installation position of the fixed rollers 24a, 24b are a little off, or when the components undergo elastic deformation, or even when the outer ring 30 undergoes thermal expansion. In other words, when the outer diameter or installation position of the fixed rollers 24a, 24b are a little off, the center roller 14 and outer ring 30 move in the radial direction as the movable roller 25 moves into the narrow-width section of the annular space 43. Also, the contact surface pressures at the areas of contact between the areas of contact between the driving-force-transmission cylindrical surfaces 32, which are the outer peripheral surfaces of the fixed rollers 24a, 24b and movable roller 25, and the drive-side cylindrical surface 42, which is the outer peripheral surface of the center roller 14, and the driven-side cylindrical surface 31, which is the inner peripheral surface of the outer ring 30, are kept at the design values. Therefore, it is possible to obtain high transmission efficiency even when the outer diameter or installation position is off a little or when the components undergo elastic deformation.

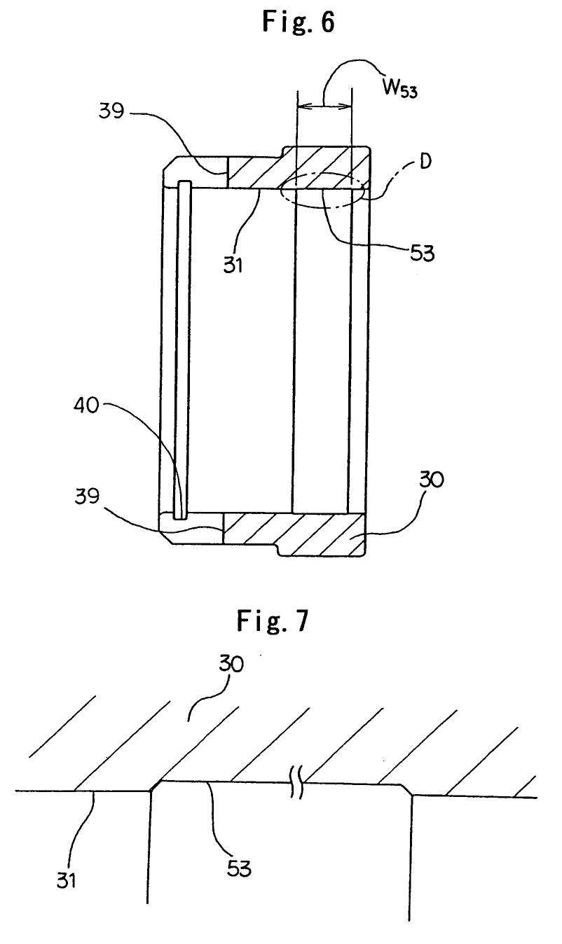

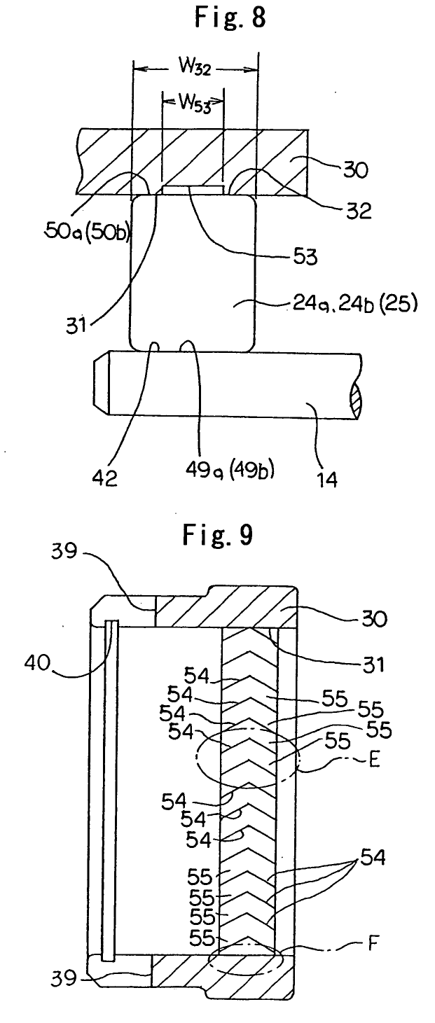

Next, FIGS. 6 to 8 show a second example of the embodiment of the invention. In this example, improvements are added to the construction of the first embodiment described above to make the contact pressures among the radially inner contact areas 49a, 49b and radially outer contact areas 50a, 50b (see FIGS. 1 and 2) nearly the same and to improve stability even more during light load. In other words, the radially inner contact areas 49a, 49b and radially outer contact areas 50a, 50b are the areas of contact between the driving-force-transmission cylindrical surfaces 32, which are the outer peripheral surfaces of the fixed intermediate rollers 24a, 24b and movable intermediate roller 25, and the drive-side cylindrical surface 42, which is the outer peripheral surface of the center roller 14, or the driven-side cylindrical surface 31, which is the inner peripheral surface of the outer ring 30. Therefore, as long as no special design is made, the width of the radially inner contact areas 49a, 49b becomes the same as the width of the radially outer contact areas 50a, 50b.

On the other hand, the radially inner contact areas 49a, 49b are areas of contact between a pair of surfaces that have a convex arc shape in the circumferential direction, where as the radially outer contact areas 50a, 50b are areas of contact between one surface that has a convex arc shape and one surface that has a concave arc shape in the circumferential direction. Therefore, when the widths of the radially inner contact areas 49a, 49b and the widths of the radially outer contact areas 50a, 50b are the same, the contact area of the radially inner contact areas 49a, 49b becomes more narrow than the contact area of the radially outer contact areas 50a, 50b. Moreover, the contact pressures of the radially outer contact areas 50a, 50b become lower than the contact pressures of the radially inner contact areas 49a, 49b by that amount, and thus it becomes difficult to maintain contact pressures at the radially outer contact areas 50a, 50b. Also, in order to solve the above problems as described in the background of the invention, it is necessary to increase the elastic force of the compression coil springs 45 (see FIGS. 2 and 3). On the other hand, when the elastic force of the compression coil springs 45 is increased, the outer ring 30 rotates with the clutch mechanism as is in the OFF state, and during the so-called overrun state, the brake drag torque becomes large, and in the worst case, it is possible that overrun cannot be performed.

In consideration of the problems described above, in the construction of this embodiment, the contact pressures at the radially inner contact areas 49a, 49b and radially outer contact areas 50a, 50b is made nearly the same, and more precisely, the difference between the contact pressures at the radially inner contact areas 49a, 49b and the radially outer contact areas 50a, 59b is kept within ±20% (as seen from the contact areas with low pressure), so as to stabilize operation during light loads even without increasing the elastic force of the compression coil springs 45.

In order to do this, in the case of the construction of this example, the widths of the radially inner contact areas 49a, 49b and the widths of the radially outer contact areas 50a, 50b are different from each other. In other words, the widths of the radiallay outer contact areas 50a, 50 are more narrow than the widths of the radially inner contact areas 49a, 49b. More specifically, a concave section 53 is formed all the way around the circumference on part of the driven-side cylindrical surface 31, which is the inner peripheral surface of the outer ring 30, that is more depressed in the radially outward direction than the other areas. This concave section 53 is formed in the section that faces the middle section in the axial direction of the driving-force-transmission cylindrical surfaces 32, and the width W₅₃ is less than the widths W₃₂ of these driving-force-transmission cylindrical surfaces 32 (W₅₃<W₃₂). Therefore, these driving-force-transmission cylindrical surfaces 32 and driven-side cylindrical surface 31 only come in contact with each other in the sections near both ends in the axial direction of these driving-force-transmission cylindrical surfaces 32.

In the case of this example, by making the widths of the radially inner contact areas 49a, 49b and the widths of the radially outer contact areas 50a, 50b different from each other, the contact pressures at these contact areas 49a, 49b, 50a, 50b are nearly the same, and thus it is possible to maintain contact pressure at the radially outer contact areas 50a, 50b and to stabilize operation during light loads even without increasing the elastic force of the compression coil springs 45.

In order to make the contact pressures nearly the same at all of the contact areas 49a, 49b, 50a, 50b by making the widths of the radially inner contact areas 49a, 49b different from the widths of the radially outer contact areas 50a, 50b, it is also possible to make a banked convex section all the way around the circumference on part of the driven-side cylindrical surface 31 which is the inner peripheral surface of the outer ring 30, that protrudes further in the radially inward direction than the other parts. In this case, only the middle section in the axial direction of the driving-force-transmission cylindrical surfaces 32 comes in contact with the inner peripheral surface of the convex section. However, in the case of this kind of construction, unlike the example shown in the figures, it is easy for the fixed rollers 24a, 24b and movable roller 25 to become tilted, and any measures must be taken to prevent tilting.

In either case, the radially outer contact areas 50a, 50b, only at part in the width direction of the driving-force-transmission cylindrical surfaces 32, come in contact with the driven-side cylindrical surface 31, so it is preferred that measures be taken such as crowning of the specific sections of the driven-side cylindrical surface 31 in order that no edge loading occurs at the boundary sections between the contact areas and non-contact areas.

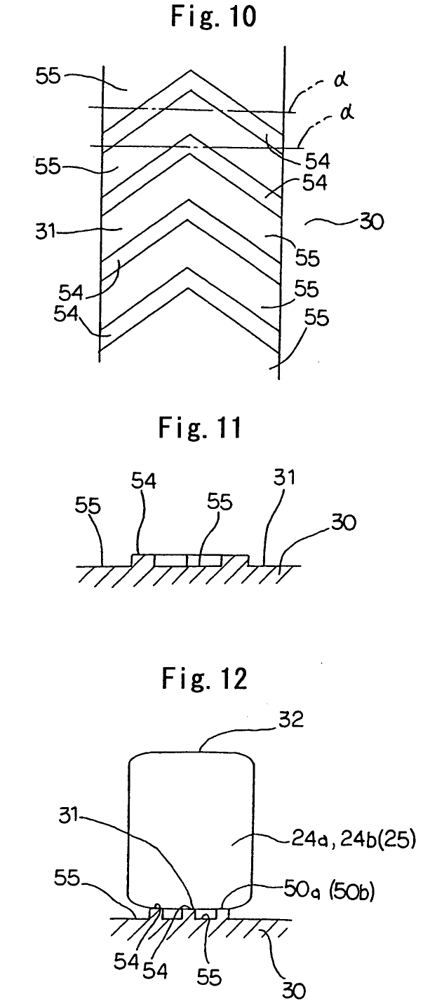

Next, FIGS. 9 to 13 show a third example of the invention. In this example, herring bone shaped convex sections 54 and concave sections 55 are formed such that they alternate and are evenly spaced around the driven-side cylindrical surface 31, which is the inner peripheral surface of the outer ring 30, in the section that comes in contact with the driving-force-transmission cylindrical surfaces 32 (see FIGS. 1 and 2), which are the outer peripheral surfaces of the fixed rollers 24a, 24b and movable roller 25. The driving-force-transmission cylindrical surfaces 32 come in contact with the convex sections 54 on the driven-side cylindrical surface 31. In other words, two of these cylindrical surfaces 32, 31 come in contact with each other in the circumferential direction in the section between the two straight lines α shown in FIG. 10, and in the axial direction in the area where the convex sections 54 are formed.

In the case of this example, by specially designing the inclination angle and width of these convex sections 54, for example, by making the area of the concave sections 55 larger than the area of the convex sections 54, the contact pressures at the radially inner contact areas 49a, 49b are nearly the same as the contact pressures at the radially outer contact areas 50a, 50b (see FIGS. 1 and 2). More specifically, the difference between the contact pressures at the radially inner contact areas 49a, 49b and radially outer contact areas 50a, 50b is kept within ±20% (as seen from the contact areas with low pressure), so that operation is stabilized during light loads even without increasing the elastic force of the compression coil springs 45 (see FIGS. 2 and 3). Also, when the outer ring 30 rotates, the concave sections 55 function as dynamic-pressure channels to make it possible to maintain the thickness of the oil layer at the contact area between the driven-side cylindrical surface 31 and the driving-force-transmission cylindrical surfaces 32, and in the overrun state, they prevent the advancement of wear in part of these driving-force-transmission cylindrical surfaces 32.

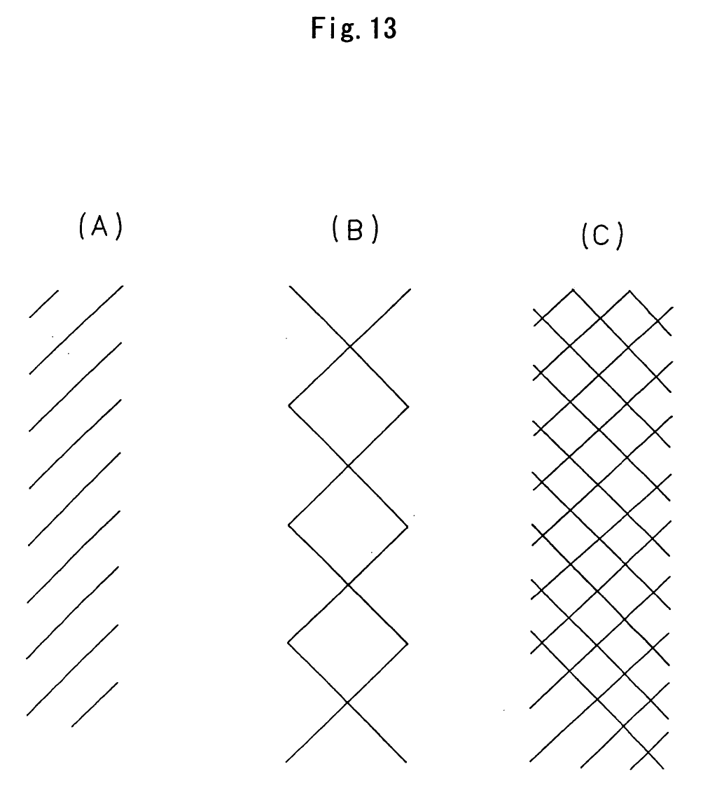

In the case of the construction of this example, there is a plurality of areas of contact between the driving-force-transmission cylindrical surfaces 32 and the driven-side cylindrical surfaces 31, so as shown in FIG. 12, when crowning is performed on each of the driving-force-transmission cylindrical surfaces 32, tilting of the fixed rollers 24a, 24b and movable roller 25 (particularly the movable roller 25) is prevented, and it becomes easy to perform design for properly distributing the surface pressure over all of the areas of contact. Moreover, the shape of the protrusions formed on the driven-side cylindrical surface 31 is not limited to the herring bone shape described above, and it is possible to use protrusions that are slanted to one side as shown in FIG. 13(A), or X-shaped protrusions as shown in FIG. 13(B), or knurling-shaped protrusions as shown in FIG. 13(C). In any case, by designing the inclination angle and width, the contact pressures at the radially inner contact areas 49a, 49b and the contact pressures at the radially outer contact areas 50a, 50b (see FIGS. 1 and 2) become nearly the same.

Next, FIGS. 14 and 15 show a fourth example of the invention. The construction of this example uses an electric motor with built-in speed reducer as the starting apparatus for an engine, such that slipping between part of the outer peripheral surface of the movable roller 25 and the inner peripheral surface of the outer ring 30 is prevented even in the so-called overrun state, where the output shaft 4 of the traction-roller speed reducer 3b rotates after starting the engine 5 (see FIG. 16), and power stops flowing to the starter motor 1a and the input shaft 2 of the traction-roller speed reducer 3b using wedging stops. In other words, in the case of the starting apparatus for an engine of this embodiment of the invention, the input shaft stops, the overrun state occurs where the output shaft 4 continues to rotate after the engine has started. In this overrun state, since the movable roller 25 does not rotate, when rubbing occurs between part of the outer peripheral surface of the movable roller 25 and the inner peripheral surface of the outer ring 30, step-shaped wear occurs on the outer surface of the movable roller 25. In the construction of this example by preventing the outer ring 30 from rotating during the overrun state, the step-shaped wear is prevented from occurring on the outer peripheral surface of the movable roller 25 even after use for a long time of period, and thus losing the function of the traction-roller speed reducer 3b is prevented.

In the construction of the electric motor with built-in speed reducer of this example, the starter motor 1a is integrated with the traction-roller speed reducer 3b, so it is possible to reduce installation space and simplify management of parts, as well as it is possible to simplify the work of assembling the motor into the automobile engine.

In other words, the electric motor with built-in speed reducer comprises the starter motor (electric motor) 1a and traction-roller speed reducer 3b, which are separated by one partition plate 56.

The rotation of the rotation-drive shaft 57 of the starter motor 1a is freely transmitted to the output shaft 4 after the speed has been reduced by the traction-roller speed reducer 3b. The rotation-drive shaft 57, around whose middle section the rotor 58 is fastened, has the base end (right end in FIG. 14) supported by a rolling bearing 60a that is located in the center of the bottom of the motor case 59, and the section in the middle near the tip end (near the left end in FIG. 14) supported by a rolling bearing 60b located in the center section of the partition plate 56 that is connected and fastened to the opening end of the motor case 59, such that they both can rotate freely. Also, a starter 61 is fastened to the inner peripheral surface of the motor case 59 such that it faces the rotor 58 During operation, the rotation-drive shaft 57 is rotated and driven according to the power flowing to the rotor 58. This rotation-drive shaft 57 is integrated into a single unit with the input shaft 2 and center roller 14a of the traction-roller speed reducer 3b.

The center roller 14a is located in the space that is surrounded by the speed-reducer case 62 and partition plate 56.

The speed-reducer case 62 is connected and fastened to the surface of the partition plate 56 on the side opposite from the motor case 59. In the case of this example, this speed-reducer case 62 corresponds to the main unit 11 in the first example described above, and the partition plate 56 corresponds to the cover 12 (see FIG. 1).

There is a through hole 15 formed in the partition plate 56 through which the center roller 14a passes, and it is located in the center of the motor case 59 at a location a little offset from the center of the partition plate 56 and the speed-reducer case 62.

The construction and function of the traction-roller speed reducer 3b, including the center roller 14a, is substantially the same as that in the case of the first example shown in FIGS. 1 and 2, so any redundant explanation will be omitted or simplified, and this explanation will center on the features of this example In the case of this example, the position in the axial direction of the center roller 14a is regulated by the pair of rolling bearings 60a, 60b. Therefore, in the case of this example, there is no pivot bearing as in the case of the first example, and instead, a circular-shaped connection plate 20a is used, which will be explained below, that has a circular hole 75 formed in its center in order to prevent interference between this connection plate 20a and the tip end (left end in FIG. 14) of the center roller 14a.

Also, three pivot shafts 21a, 21b, 21c are arranged inside the speed-reducer case 62 in the section surrounding the center roller 14a such that they are parallel with the center roller 14a. In other words, one end (the right end in FIG. 1) of these pivot shafts 21a, 21b, 21c is supported by the partition plate 56 while the other end (the left end in FIG. 1) is supported by the connection plate 20a that is located on the inside in the middle section in the axial direction of the speed-reducer case 62.

For details about these three pivot shafts 21a, 21b, 21c, refer to the explanation for FIGS. 1 to 3 above.

In the case of this example, the end (left end in FIG. 14) of a cylindrical-shaped outer ring 30, which is located inside the speed-reducer case 62 such that it can rotate freely, is connected to the base end (right end in FIG. 14) of the output shaft 4 of the traction-roller speed reducer 3b by way of a transmission bracket 63 and roller clutch 64 such that rotation force can be transmitted freely.

The position in the radial direction can be adjusted a little, however, for detail concerning that, refer to the explanation of the notches 39, protrusions 38 and retaining ring 41 in FIGS. 1 to 3.

In the example shown in the figures, there is a roller clutch 64 and a single deep-groove support ball bearing 66 between the inner peripheral surface of the cylinder section 65 that is formed on the inner peripheral edge of the collar section 33a of the transmission bracket 63 and the outer peripheral surface on the base end of the output shaft 4, and they are both offset in the axial direction and located parallel with respect to each other in the direction that the rotation force is transmitted. Well known conventional construction is used for the roller clutch 64, which is a one-way clutch, and it comprises: the outer clutch ring 67, clutch retainer 68, a plurality of rollers 69 and the same number of springs (not shown in the figure) as there are rollers 69.

By arranging the same number of concave sections, called ramp sections, as there are rollers 69 around the outer clutch ring 67 such that they are evenly spaced in the circumferential direction, and such that they run in the axial direction (left-right direction in FIG. 14), the inner peripheral surface of the outer clutch ring 67 is taken to be a cam surface. Also, the width in the radial direction of the cylindrical space that exists between the outer peripheral surface on the base end of the output shaft 4 and the inner peripheral surface of the outer clutch ring 67 is made to be larger than the outer diameter of the rollers 69 at the section that corresponds to the concave sections, and less than the outer diameter of the rollers 69 in the section that is separated from these concave sections. Moreover, the clutch retainer 68 is assembled on the inner-diameter side of the outer clutch ring 67 to prevent relative rotation with respect to the outer clutch ring 67. Also, cach of the springs presses the rollers 69 in the same direction in the circumferential direction such that they move away from the convex sections.

This kind of roller clutch 64 is located between the inner peripheral surface on one half (right half in FIG. 1) of the cylinder section 65 and the outer peripheral surface of the base end of the output shaft 4 when the outer clutch ring 67 is fastened on the inside of one half end of the cylinder section 65. In this state, the direction of assembly is regulated such that the roller clutch 64 is connected only when the outer ring 30 rotates in the counterclockwise direction of FIG. 15 and the outer clutch ring 67, together with the transmission bracket 63, tends to rotate in the same direction relative to the output shaft 4, and such that the rotation force is transmitted from the transmission bracket 63 to the output shaft 4. The construction and function of the roller clutch 64 is well known so any further detailed drawings and explanation are omitted.

Also, a support bearing 66 is located between the inner peripheral surface on the other half (left half in FIG. 14) of the cylinder section 65 and the outer peripheral surface in the middle section near the base end of the output shaft 4, such that the transmission bracket 63 can rotate relative around the base end of the output shaft 4 and be positioned in the radial and axial direction. Therefore, the inner race of the support bearing 66 is fastened around the outer peripheral surface of the output shaft 4 and positioned in the axial direction by a stepped section and retaining ring. And, the outer race of the support bearing 66 is fastened around the inner peripheral surface of the cylinder section 65 and positioned in the axial direction by a pair of retaining rings. By using this kind of support bearing 66, the inner peripheral surface of the cylinder section 65 is supported concentric with the outer peripheral surface on the base end of the output shaft 4, and the space between the outer peripheral surface on the base end of the output shaft 4 and the inner peripheral surface of the outer clutch ring 67 is uniform all the way around the circumference except for the amount of change due to the uneven cam surface.

Also, the middle section of the output shaft 4 is supported by a pair of deep-groove or angular ball bearings 36a, 36b on the inner diameter side of a support cylinder section 35a located in the speed-reducer case 62 such that it can only rotate freely. Furthermore, on the tip end (left end in FIG. 14) of the output shaft 4 in the section that protrudes out from the support cylinder section 35a of the speed-reducer case 62 there is a drive pulley 70 that is supported such that the rotation force can be freely transmitted by way of a key 71. Also, a nut 72 is screwed onto the male-screw section that is formed on the section of the tip end of the output shaft 4 that protrudes from the drive pulley 70 to connect and fasten the drive pulley 70 to the output shaft 4. Of the pair of ball bearings 36a, 36b, the load capacity of the ball bearing 36a on the side next to the drive-pulley 70 that is the support point for supporting a moment load applied to the output shaft 4 due to the tension force of a continuous belt 10 (see FIG. 16) that is placed around the drive pulley 70 is larger than the load capacity of the ball bearing 36b on the side away from the drive pulley 70. Therefore, optimum design for sufficiently maintaining durability is possible without having to unnecessarily increase the size of both of these ball bearings 36a, 36b.

For details concerning the relationship between the fixed rollers 24a, 24b, movable roller 25 and center roller 14a of the traction-roller speed reducers 3a, 3b, refer to the explanation of FIGS. 1 to 3. The through hole 15 that is formed in the partition plate 56 of this example corresponds to the through hole 15 through which the center roller 14 shown in FIGS. 1 and 2 passes.

When using an electric motor with built-in speed reducer, assembled with the traction-roller speed reducer 3b of this example described, as the starting apparatus for an engine, the rotation-drive shaft 57 and center roller 14a are rotated in the clockwise direction of FIG. 15 according to the electric power flowing to the rotor 58.

The rotation of the center roller 14a is transmitted to the outer ring 30 by the same action as that in the first example described above.

In the case of an electric motor with built-in speed reducer, assembled with the traction-roller speed reducer 3 described above, the rotation-drive shaft 2 and center roller 10 are rotated in the clockwise direction of FIG. 2 according to the electric power flowing to the rotor 5. When the rotation-drive shaft 2 and center roller 10 rotate, the movable roller 25 rotates in the counterclockwise direction in FIG. 15, and transmits the rotation force from the center roller 14a to the outer ring 30 and rotates the outer ring 30 in the counterclockwise direction in the same figure. As a result, the movable roller 25 receives a force, which acts in the same direction as the pressing force from the pressure pin 47, from the drive-side cylindrical section 42, which is the outer peripheral surface of the center roller 14a, and from the driven-side cylindrical surface 31, which is the inner peripheral surface of the outer ring 30, and it tends to move toward the narrow-width section of the annular space 43, or in other words, the center bottom section in FIG. 15.

As a result, the driving-force-transmission cylindrical surface 32, which is the outer peripheral surface of the movable roller 25, strongly presses against the drive-side cylindrical surface 42 and driven-side cylindrical surface 31. Also, the contact pressures at the radially inner contact area 45a, which is the area of contact between this driving-force-transmission cylindrical surface 32 and drive-side cylindrical surface 42, and at the radially outer contact area 50a, which is the area of contact between this driving-force-transmission cylindrical surface 32 and the driven-side cylindrical surface 31, increase. The outer ring 30, which is supported such that it can move a little in the radial direction with respect to the output shaft 4, and that it is pressed by the driving-force-transmission cylindrical surface 32 on the outer peripheral surface of the movable roller 25, moves a little in the radial direction as the contact pressure of the radially inner contact area 49a and the radially outer contact area 50a with respect to the movable roller 25 increases. As a result, the contact pressures at the radially inner contact areas 49a and radially outer contact areas 50a on the fixed rollers 24a, 24b increase. Also, the rotation force from the rotation-drive shaft 2 and center roller 14a is freely transmitted to the outer ring 30 and transmission bracket 62 by way of the fixed rollers 24a, 24b and movable roller 25 based on th friction engagement between these contact areas 49a, 50a.

The rotation of the outer ring 30 is transmitted from the transmission bracket 63 to the output shaft 4 by way of the roller clutch 64, and causes this output shaft 4 to rotate at the same speed and direction as the outer ring 30. Furthermore, the rotation of the output shaft 4 is transmitted to the driven section of the engine 5, or in other words the rotating shaft 6 (see FIG. 16), by way of the drive pulley 70 and continuous belt 10 that is placed around the drive pulley 70, and this rotates and drives the rotating shaft 6 to start the engine 5.

Moreover, in the case of the traction-roller speed reducer 3 assembled in the electric motor with built-in speed reducer shown in FIGS. 14 and 15, it is possible to keep the contact pressures at the radially inner contact areas 49a and radially outer contact areas 50a on the fixed rollers 24a, 24b within the design values even when the outer diameter or installation position of the fixed rollers 24a, 24b, which transmit the rotation driving force, are a little off, or when the components undergo elastic deformation, or even when the outer ring 30 undergoes thermal expansion. In other words, since the outer ring 30 is supported such that it can move a little with respect to the output shaft 4, the outer ring 30 moves a little in the radial direction when the outer diameter or installation position of the fixed rollers 24a, 24b are off a little and the movable roller 25 moves toward the narrow-width section of the annular space 43. Also, the contact pressures at the radially inner contact areas 49a and radially outer contact areas 50a on the fixed rollers 24a, 24b and movable roller 25 (all of the intermediate rollers) are kept within the designed values. Therefore, high transmission efficiency can be obtained even when the aforementioned outer diameter or installation position is off a little, or when the components undergo elastic deformation or even when the outer ring 30 undergoes thermal expansion.

When starting the engine 5 in this way, similar to the case of the first example described above, the torque transmitted by way of the traction-roller speed reducer 3b changes suddenly. However, in this example as well, the elastic force from each of the compression coil springs 45 that press the movable roller 25 is maintained. Therefore, in the cranking process for starting the engine 5, the contact pressures at each of the radially inner contact areas 49a, 49b and radially outer contact areas 50a, 50b are maintained even when the torque for rotating and driving the rotating shaft 6 of the engine 5 decreases suddenly, and thus it is possible to prevent severe sliding at these contact areas 49a, 49b, 50a, 50b, and to prevent damage such as seizure from occurring.

On the other hand, when the output shaft 4 rotates after the engine 5 has started and the rotation-drive shaft 57 and center roller 14a has stopped, or in other words, when the speed of rotation of the output shaft 4 becomes faster than the speed corresponding to the speed of rotation of the center roller 14a (this speed divided by the speed-reduction ratio of the traction-roller speed reducer 3b), the roller clutch 64 is disconnected.

In this state, the base end of the output shaft 4 rotates inside the outer clutch ring 67 of the roller clutch 64 in a direction with respect to this outer clutch ring 67 that is opposite the direction that the springs (not shown in the figure) press the rollers 69. As a result, duo to the rolling friction with the outer peripheral surface of the base end of the output shaft 4, the rollers 69 move toward the section that corresponds the concave section, called the ramp section formed around the inner peripheral surface of the outer clutch ring 67 due to the elastic force from the springs, and they rotate in this section.

As a result of the rollers 69 rotating between the inner peripheral surface of the outer clutch ring 67 and the outer peripheral surface of the base end of the output shaft 4 in this way, the roller clutch 64 is put into the so-called overrun state, and this roller clutch 64 is disconnected. Also, the rotation of the output shaft 4 is no longer transmitted to the transmission bracket 63, so the outer ring 30 of the traction-roller speed reducer 3b also stops rotating. As a result, there is no slipping between the driven-side cylindrical surface 31, which is the inner peripheral surface of the outer ring 30, and the driving-force-transmission cylindrical surface 32, which is the outer peripheral surface of the movable roller 25, and thus there is also no longer any wear of this driving-force-transmission cylindrical surface 32.

The elastic force of the springs assembled in the roller clutch 64 to press the rollers 69 can be small. Also, in the example shown in the figures, when the support bearing 66 is used, the inner peripheral surface of the outer clutch ring 67 and the outer peripheral surface of the base end of the output shaft 4 are supported such that they are concentric with each other, so during the overrun state there is a space between both of these peripheral surface that allows for all of the rollers 69 to roll. Therefore, during the overrun state, the rollers 69 roll smoothly and there is hardly any sliding contact between the rolling surface of the rollers 69 and the inner peripheral surface of the outer clutch ring 67 or outer peripheral surface of the base end of the output shaft 4 even when rolling contact occurs. Moreover, even in the case that sliding contact occurs, the circumferential speed of the contact section is slower than the circumferential speed of inner peripheral surface of the outer ring 30, and the surface pressure at the rubbing section is low, so there is no severe wear at this contact section. Also, when the roller clutch 64 is in the overrun state, the rotation-drive shaft 57 of the starter motor 1a is not rotated or driven, so the starter motor 1a does not resist against the rotation of the driven sections such as the crankshaft.

Furthermore, in the case of the starting apparatus for an engine or the electric motor with built-in speed reducer of this example, the base end of the output shaft 4 is placed inside the inner-diameter side of the outer ring 30, and part of the roller clutch 64 is arranged such that is around this section that is inside the outer ring 30. Therefore, it is possible to keep the distance L in the axial direction from the surface on the base end of the outer ring 30 (surface on the right end in FIG. 14) to the edge on the end of the roller clutch 64 small, and to reduce the dimensions in the axial direction of the entire unit of the integrated starter motor 1a and traction-roller speed reducer 3b, and thus it is possible to make the apparatus more compact and lightweight.

Using the electric motor with built-in speed reducer of this invention as the source of the driving force for the starting apparatus of an automobile engine is very effective. Particularly, when used as the starting apparatus for a vehicle for which the engine must be started in a short period of time, such as in the case of an idling-stop vehicle, the time from when electric power flows to the electric motor until the engine starts can be reduced, and this greatly contributes to lowering irritation of the operator. In this kind of case, in order to transmit the driving force from the output shaft 4 to the crankshaft, it is not always necessary to use an endless belt. It is also possible to fasten a pinion gear to the tip end of the output shaft 4, and for this pinion gear to mesh with a driven gear that is formed on the flywheel of the engine. Furthermore, when used as an auxiliary power source for an electric-motor-assisted bicycle, or the power source of an electric car or hybrid car, the driving force from the electric motor is transmitted with good efficiency to the driven section, and when this electric motor is stopped, the existence of this electric motor does not resist the rotation of the driven section.

The traction-roller speed reducer 3b also functions as a one-way direction clutch as described above, so even if for some reason the roller clutch 64 seizes up, the rotation of the output shaft 4 will not be transmitted to the rotation-drive shaft 57 of the starter motor 1a when the output shaft 4 is rotating at high speed after the engine 5 has started. Therefore, even when the roller clutch 64 seizes up and the output shaft 4 and outer ring 30 rotate together in synchronization regardless of the direction that the rotation force is transmitted, the starter motor 1a will not be damaged. Also, the engine 5 can still be started. Therefore, by performing repair promptly, only the roller clutch 64 need be replaced, and even when the automobile has been operated a long distance at time of repair, only the traction-roller speed reducer 3b need be replaced together with the roller clutch 64.

As described above, with this invention, the components of the traction-roller speed reducer, which is located in the transmission path of transmitting the driving force from the starter motor to the rotating shaft of the engine, are prevented from damage due to severe slipping, and it is possible to improve durability of the starting apparatus for an engine in which this traction-roller speed reducer is assembled.

Furthermore, this invention makes possible a compact and lightweight electric motor with built-in speed reducer that has good freedom with regard to installation space and that has excellent durability, and thus makes it possible to improve the practicability of an electric motor with built-in speed reducer.

What is claimed is:

1. A starting apparatus for an engine comprising a traction-roller speed reducer and a rotation-power transmission means, which are provided between a starter motor and the engine and in series with reference to the power transmission direction, the traction-roller speed reducer comprising: a housing; an input shaft that can rotate freely with respect to the housing, a center roller that is concentric with the input shaft and connected to an end of the input shaft and to which the rotation force is freely transmitted and whose outer peripheral surface is taken to be a drive-side cylindrical surface; an outer ring that is located around the center roller and whose inner peripheral surface is taken to be the driven-side cylindrical surface that rotates relative to the center roller; an output shaft that is concentric with the outer ring and where one end is linked to the outer ring such that rotation force can be freely transmitted and is supported such that it rotates freely with respect to the housing; a plurality of pivot shafts that are located in the annular space between the drive-side cylindrical surface and the driven-side cylindrical surface such that they are arranged parallel with the center roller; and a plurality of intermediate rollers that are supported by the respective pivot shafts such that they rotate freely and whose outer peripheral surfaces are taken to be the driving-force-transmission cylindrical surfaces, respectively,
the center of the center roller being made eccentric with the center of the outer ring, whereby the width dimension of the annual space is not uniform in the circumferential direction, and one of the plurality of intermediate rollers being a movable roller that is supported such that it can move freely in the circumferential direction inside the annular space and the remaining intermediate rollers being fixed rollers, the intermediate roller that is the movable roller will freely move toward the narrow-width section of the annular space when the center roller and outer ring rotate in a specified direction,
wherein by elastically pressing the intermediate roller that is the movable roller in the traction-roller speed reducer toward the narrow-width section of the annular space, a pre-load is applied for causing contact pressure to occur at the areas of contact between the driving-force-transmission cylindrical surface on the intermediate roller that is the movable roller and the drive-side cylindrical surface and driven-side cylindrical surface, even in the no-load state, and
wherein when the maximum value of the circumferential speed of the drive-side cylindrical surface during operation is taken to be Umax [m/sec], and the average value of the contact pressure due to preloading at the areas of contact between the driven-side cylindrical surface and the driving-force-transmission cylindrical surface on the intermediate roll r that is the movable roller is taken to be Pmean [GPa], Pmean≦0.3 [GPa] and Pmean>{(Umax)^{1/2}}/9 are satisfied.

2. A starting apparatus for an engine comprising a traction-roller speed reducer and a rotation-power transmission means, which are provided between a starter motor and the engine and in series with reference to the power transmission direction, the traction-roller speed reducer comprising a housing; an input shaft that can rotate freely with respect to the housing, a center roller that is concentric with the input shaft and connected to an end of the input shaft and to which the rotation force is freely transmitted and whose outer peripheral surface is taken to be a drive-side cylindrical surface; an outer ring that is located around the center roller and whose inner peripheral surface is taken to be the driven-side cylindrical surface that rotates relative to the center roller; an output shaft that is concentric with the outer ring and where one end is linked to the outer ring such that rotation force can be freely transmitted and is supported such that it rotates freely with respect to the housing; a plurality of pivot shafts that are located in the annular space between the drive-side cylindrical surface and the driven-side cylindrical surface such that they are arranged parallel with the center roller; and a plurality of intermediate rollers that are supported by the respective pivot shafts such that they rotate freely and whose outer peripheral surfaces are taken to be the driving-force-transmission cylindrical surfaces, respectively,
the center of the center roller being made eccentric with the center of the outer ring, whereby the width dimension of the annual space is not uniform in the circumferential direction, and one of the plurality of intermediate rollers being a movable roller that is supported such that it can move freely in the circumferential direction inside the annular space and the remaining intermediate rollers being fixed rollers, the intermediate roller that is the movable roller will freely move toward the narrow-width section of the annular space when the center roller and outer ring rotate in a specified direction,
wherein by elastically pressing the intermediate roller that is the movable roller in the traction-roller speed reducer toward the narrow-width section of the annular space, a pre-load is applied for causing contact pressure to occur at the areas of contact between the driving-force-transmission cylindrical surface on the intermediate roller that is the movable roller and the drive-side cylindrical surface and driven-side cylindrical surface, even in the no-load state, and
wherein when and the average value of the contact pressure at the areas of contact between the driven-side cylindrical surface and the driving-force-transmission cylindrical surface on the intermediate roller that is the movable roller is taken to be Pmean [GPa], Pmean>0.3 [Gpa] is satisfied.

3. The starting apparatus for engine of any one of claims 1 to 2, wherein the contact surface pressure at the radially inner contact areas that are the areas of contact between the driving-force-transmission cylindrical surfaces and the drive-side cylindrical surface, and the radially outer contact areas that are the areas of contact between the driving-force-transmission cylindrical surfaces and the driven-side cylindrical surface are substantially the same to each other, with a difference within ±20% therebetween.

4. The starting apparatus for engine of anyone of claims 1 to 3, wherein the radially inner contact areas that are the areas of contact between the driving-force-transmission cylindrical surfaces and the drive-side cylindrical surface is different in width from the radially outer contact areas that arc the areas of contact between the driving-force-transmission cylindrical surfaces and the driven-side cylindrical surface.

5. The starting apparatus for engine of claim 4, wherein the width of the radially outer contact areas are smaller than the width of the radially inner contact areas.

6. The starting apparatus for engine of claim 5, wherein axial part of the inner peripheral surface of the outer race is radially inwardly recessed generally circumferentially comparing with the other part to form a recess.

7. The starting apparatus for engine of claim 6, wherein the recess is formed in a portion facing the axially intermediate portion of the driving-force-transmission cylindrical surfaces, and wherein the driving-force-transmission cylindrical surfaces come into contact with the driven-side cylindrical surface at a portion near the axial opposite ends of the driving-force-transmission surfaces.

8. The starting apparatus for engine of anyone of claims 1 to 3, wherein recesses and lands are alternately formed in the circumferential direction in a portion of the inner peripheral surface of the outer race in contact with the driving-force-transmission cylindrical surfaces such that the recesses and lands are tilted in the axial direction.

9. The starting apparatus for engine of claim 8, wherein the lands are larger in area than the recess

10. The starting apparatus for engine of anyone of claims 1 to 9, wherein crowning is provided on the driving-force-transmission cylindrical surfaces.

11. The starting apparatus for engine of anyone of claims 1 to 10, wherein the rotation power transmission means comprises a first pulley fixed to the output shaft of the traction roller type transmission, a second pulley fixed to the rotating shaft of the engine, and an endless belt extending between the first and second pulleys.

12. The starting apparatus for engine of anyone of claims 1 to 10, wherein the rotation power transmission means comprises a small reduction gear fixed to the output shaft of the traction roller type transmission and a large reduction gear fixed to the rotating shaft of the engine and meshed with the smaller reduction gear.

13. The starting apparatus for engine of anyone of claims 1 to 12, wherein the output shaft and the outer race in the traction roller type speed reducer are substantially concentric with each other and rotatable relative to each other, and wherein at least part of the base end of the output shaft enters into the radially inside of the outer race, and wherein a one-way clutch is provided between the outer peripheral surface of the base end of the output shaft and the outer race, such that the one-way clutch is connected only when the rotation of the outer race based on the power-on to the starter motor is transmitted to the output shaft.

14. The starting apparatus for engine of claim 13, wherein the one-way clutch is a roller clutch, and wherein a ball bearing of a single-row deep groove type is provided together with the one-way clutch between the inner peripheral surface of the cylindrical portion that is rotated together with the outer race and the outer peripheral surface of the base end of the output shaft such that they are axially displaced from each other and in parallel to each other with reference to the rotating power transmission direction.

15. An electric motor integral with a speed reducer comprising an electric motor, a rotating drive-shaft of the electric motor, an input shaft provided integral with the tip end of the rotating drive-shaft, and a speed reducer for taking the rotation of the input shaft through an output shaft after reduction, the speed reducer being a traction-roller speed reducer comprising: a center roller that is integral with the input shaft; an outer ring that is located around the center roller and eccentric relative to the center roller; at least two fixed rollers and one movable roller that are located in the annular space between the drive-side cylindrical surface that is the outer peripheral surface of the center roller and the driven-side cylindrical surface that is the inner peripheral surface of the outer race such that the radial width of the annular space is uneven in the circumferential direction such that the outer peripheral surfaces arc taken to be the driving-force-transmission cylindrical surfaces,
wherein the fixed rollers are only rotatable with its center on the support shaft while the movable roller is rotatable with its center on the support shaft and movable at least circumferentially in the annunlar space, and wherein the movable roller is elastically pressed toward the narrow-width section of the annular space,
wherein the output shaft and outer race are substantially concentric with each other and movable relative to each other in the traction roller speed reducer, wherein at least part of the base end of the output shaft enters into the radial inside of the outer race, wherein one-way clutch is provided between the outer peripheral surface of the base end of the output shaft and the outer race, such that the one-way clutch is connected only when the rotation of the outer race based on the power-on to the elastic motor is transmitted to the output shaft.

16. The electric motor integral with the speed reducer of claim 15, wherein the one-way clutch is a roller clutch, and wherein a ball bearing of a single-row deep groove type is provided together with the one-way clutch between the inner peripheral surface of the cylindrical portion that is rotated together with the outer race and the outer peripheral surface of the base end of the output shaft such that they are axially displaced from each other and in parallel to each other with reference to the rotating power transmission direction.
